(19) United States
(12) Patent Application Publication
(10) Pub. No.: US 2025/0148910 A1
(43) Pub. Date: May 8, 2025

(54) COLLABORATIVELY MONITORING AN AUTONOMOUS VEHICLE OPERATION ZONE

(71) Applicant: Volvo Autonomous Solutions AB, Göteborg (SE)

(72) Inventors: Linus HAGVALL, Göteborg (SE); Stefan BERGQUIST, Göteborg (SE)

(73) Assignee: Volvo Autonomous Solutions AB, Göteborg (SE)

(21) Appl. No.: 18/837,049

(22) PCT Filed: Feb. 10, 2022
(86) PCT No.: PCT/EP2022/053265

§ 371 Date: Aug. 8, 2024

(51) Int. Cl. G08G 1/0967; B60W 60/00; G06F 18/24; G08G 1/01

(52) U.S. Cl. CPC G08G 1/096708; B60W 60/001; G06F 18/24; G08G 1/0112; G08G 1/096766; B60W 2556/45

(57) ABSTRACT

A computer implemented method for monitoring an autonomous operating zone, AOZ, including a number of one or more autonomous vehicles, is provided. Each vehicle has sensors arranged to detect an ego-position of the vehicle and relative positions of surrounding objects. At an object location correlating entity receiving in real-time data from an autonomous vehicle operating in the AOZ, the real-time data comprising a report including an ego-position of the vehicle, one or more positions and/or poses of objects detected by the vehicle, responsive to receiving the report: determining a detected object location for each detected object based on the reported vehicle ego-position and reported detected object position relative to the vehicle ego-position, determining a correlation for each determined object location with one or more expected object locations in the AOZ, and determining if the object is an expected object or unexpected object at the determined object location based on the correlation meeting a correlation condition.

The disclosed technology relates to monitoring an autonomous vehicle operation zone and to other aspects.

### BACKGROUND

Monitoring an autonomous vehicle operation zone, for example, a building site, mining site, or the like, can be done a number of different ways. For example, operators of a site where autonomous vehicles are deployed may be required to ensure that only certain actors are present in the autonomous operating zone, AOZ. This may require erecting barriers and the like to restrict access to the AOZ, and additional training for site personnel. The actors and their behaviours inside the AOZ may be quantified and analyzed by monitoring and interpreting historical data at a remote unit configured to monitor the AOZ or by one or more other vehicles in the AOZ.

Determining when an unexpected actor has entered an AOZ can be particularly problematic as can be detecting unexpected behaviour of a known actor. Whilst an automated driving system, ADS, may be equipped with an obstacle detection system, detecting an object in an area where there should not be any obstacle could be seen as a sign that the operating conditions are no longer valid rather than the obstacle is unexpected. A problem accordingly exists in distinguishing between when a vehicle ADS has detected an unexpected object or unexpected behavior of an object and when the ADS has made a false detection or some other form of error has occurred in the object detection.

The disclosed technology is particularly useful for vehicles which are automated to some degree, in other words, which have an automated driving system and electronic control unit configured to control operation of the vehicle. Examples of automated vehicles include autonomous, semi-autonomous and remote controlled vehicles.

The disclosed technology will be described mainly with respect to vehicles without limitation to a particular type of vehicle. Such vehicles may include heavy-duty vehicles, such as semi-trailer vehicles and trucks as well as other types of vehicles such as cars and vehicular machines such as agricultural and mining vehicular machines. Heavy-duty vehicles may comprise a wide range of different physical devices, such as combustion engines, electric machines, friction brakes, regenerative brakes, shock absorbers, air bellows, and power steering pumps which are commonly known as Motion Support Devices (MSD). The MSDs may be individually controllable, for instance such that friction brakes may be applied at one wheel, i.e., a negative torque, while another wheel on the vehicle, perhaps even on the same wheel axle, is simultaneously used to generate a positive torque by means of an electric machine. The automated or autonomous operation of a heavy-duty vehicle is accordingly more complex than the automated or autonomous operation of a more light-weight vehicle such as a car.

### SUMMARY

This summary is provided to introduce simplified concepts that are further described below in the Detailed Description. This summary is not intended to identify essential features of the claimed subject matter, nor is it intended for use in determining the scope of the claimed subject matter.

According to a first aspect of the disclosed technology, a computer implemented method for monitoring an autonomous operating zone, AOZ, including a number of one or more autonomous vehicles, each vehicle with sensors arranged to detect an ego-position of the vehicle and relative positions of surrounding objects, comprises at an object location correlating entity receiving in real-time data from an autonomous vehicle operating in the AOZ, the real-time data comprising a report including an ego-position of the vehicle, one or more positions and/or poses of objects detected by the vehicle, responsive to receiving the report: determining a detected object location for each detected object based on the reported vehicle ego-position and reported detected object position relative to the vehicle ego-position, determining a correlation for each determined object location with one or more expected object locations in the AOZ, and determining if the object is an expected object or unexpected object at the determined object location based on the correlation meeting a correlation condition.

Advantageously, the system allows for better understanding of the operational design domain, ODD, environmental conditions in which a vehicle is operating. If a vehicle with an automated driving system, ADS, is not operating in its expected environmental conditions of an AOZ, it is difficult to predict the vehicle's performance. The disclosed method of monitoring an AOZ improves understanding of the conditions in the AOZ which is not only key to be able to argue safety for an ADS, but is also important for nominal system performance.

In some embodiments, the method further comprises: classifying the type of detected object at the determined object location, and disregarding the detected object from subsequent monitoring of the AOZ dependent on the classified type of the detected object.

In some embodiments, the method further comprises responsive to determining the location in the AOZ of a detected object, checking if the determined location is within a sub-area of the AOZ excluded from monitoring for unexpected objects, and if so, disregarding the detected object in subsequent monitoring of the AOZ.

Advantageously, the disclosed methods of monitoring an AOZ may improve understanding the ODD of a vehicle with an ADS operating in the AOZ, for example, what type of actors are expected to interact or simply exist in the vicinity of a vehicle which includes an ADS may become more visible to a central unit monitoring the AOZ in some embodiments. Depending on the use case the type of actors can be more or less controlled. It ranges from public road where almost any actor could occur to certain confined sites where the ADS might even operate in what is essentially a robot cell with no other actors. Certain actors may be allowed, or expected, in certain areas but only with certain behavior, or pose(s). Here an object's pose is not limited to just its orientation but may also include an object's size and/or configuration, which allows for large static objects such as earthworks to potentially change shape despite being static. The disclosed methods of monitoring an AOZ according advantageously are able to classify various types of actors as expected or unexpected in a more consistent manner.

In some embodiments, the object location correlating entity comprises one or more other autonomous vehicles operating in the AOZ. In some embodiments, the monitoring method may be implemented as a collaborative monitoring method. In some embodiments of the collaborative monitoring method, each of the one or more of the vehicles acting as an object location correlating entity also reports its location information and may also report information relating to any objects it has detected in its vicinity to a central unit or remote system and/or to one or more other vehicles acting as object location correlating entities.

In some embodiments, the object location correlating entity comprises central unit configured to receive reports from one or more vehicles operating in the AOZ.

In some embodiments, determining the correlation comprises comparing each determined detected object location with one or more expected object locations in the AOZ retrieved from a data store of expected static object locations, wherein if the determined detected object location meets the correlation condition, the detected object is classified as an expected static object at that location in the AOZ.

In some embodiments, determining the correlation comprises comparing in real-time the determined detected object location with one or more expected object locations in the AOZ.

In some embodiments, the one or more expected object locations are locations of one or more vehicles reported in real-time by the one or more vehicles.

In some embodiments, the correlation is determined by determining the location in the AOZ of each detected object, based on the reported timing information for each detected object, determining locations of moving actors in the AOZ, and comparing the determined location of each detected object in the AOZ at the time of its detection by the vehicle with the determined location at that time of one or more moving actors in the AOZ. If the determined location of a detected object in the AOZ at the time the object was detected correlates with the determine location of a moving actor at that time in the AOZ, the detected object is classified as an expected moving actor in the AOZ.

In some embodiments, the correlating determines the detected object comprises another autonomous vehicle operating in the AOZ, based on that autonomous vehicle's reported location.

In some embodiments, the method further comprises determining a confidence score for each detected object determined to be an unexpected object at the determined location base on the number of one or more other vehicles of the plurality of vehicles which have also detected an object at that determined location in the AOZ.

In some embodiments, the one or more other vehicles comprises two or more vehicles.

In some embodiments, the method further comprises the correlating entity processing for at least one detected object reported in a received report, object behavioural information, wherein the correlating comprises comparing the object behavioural information with expected behavioural information for one or more expected actors in the AOZ, and wherein the at least one detected object is classified as an unexpected object and/or as an object having unexpected behaviour in the AOZ if the behaviour of the detected object does not match the behaviour of an expected object in the AOZ.

In some embodiments, the report includes timing information for when each object was detected by the vehicle.

In some embodiments, timing information for when each object was detected by the vehicle is determined by the object location correlating entity based on a time when the real-time data report including the detected object was received by the correlating entity.

In some embodiments, the method further comprises the correlating entity receiving object behavioural information representing one or more movement, position, and/or pose characteristics of the object at one or more locations reported by a vehicle in the AOZ over a period of time, and generating a behavioural pattern for that period of time for the detected object based on the received behavioural information, wherein the correlating comprises determining if the generated behavioural pattern correlates with a stored behaviour pattern comprising expected movement characteristics, positions and poses for an object at the detected one or more locations.

In some embodiments, the object behavioural information includes information representing a role of the object, and the method further comprises determining if the monitored movement characteristics and position of the moving object match expected movement characteristics and positions for the role of the object.

In some embodiments, the method further comprises determining a confidence score for a detected object to be an unexpected object (20).

In some embodiments, the confidence score is based on the confidence determined by each vehicle for its object detection which is also included in the reported information to the object location correlating entity.

In some embodiments, the confidence score increases depending on the number of other vehicles that also reported they had detected the unexpected object at that location in the AOZ.

In some embodiments, the confidence score increases depending on the confidence each individual vehicle has in its detection.

In some embodiments, the correlation condition for the location of the detected object to match a location of an expected object comprises the correlation exceeding a minimum amount of correlation. In some embodiments, in addition, the method further comprises configuring the minimum amount of correlation for the AOZ, for example, based on the size of the AOZ and/or the activity levels of objects in the AOZ.

Examples of the minimum amount of correlation include less than a meter, a meter or more, or 2 m, 3 m, or even 5 m, depending on the level of desired accuracy. The amount of correlation required may also be dynamically adjusted to take into account the number of vehicles operating at any given time in the AOZ, in other words, it may depend on the vehicle density in the AOZ. It may also depend on the type of vehicles and/or the role of vehicles operating in the AOZ.

In some embodiments, the AOZ comprises one of a public road, an open site, and a closed site.

In some embodiments, the vehicle is a heavy-duty vehicle.

In some embodiments, responsive to determining a detected object is an unexpected object, the method further comprises performing an action comprising one or more of the following:

generating an alert to an operator in the AOZ, causing one or more autonomous vehicles operating on the site to shut-down or restrict or pause or slow operation in the AOZ or in a sub-area of the AOZ comprising at least the vicinity of the unexpected object in the AOZ,

shut down all ADS in the AOZ or in a subarea of the AOZ in the vicinity of the detected object, restricting operation in the entire AOZ, or only in the vicinity of the detected object to only allow operation by a vehicle having an ADS with a certain subset of functionality implemented; and closing down a sub-area of the AOZ in the vicinity of the detected object and divert operations to other parts of the site to avoid the sub-area in the vicinity of the detected object.

In some embodiments, the alert may be audible and/or visual, and it may be displayed on a monitor or announced to an individual, such as a site operator or site overseer, or provided as an announcement or site wide siren.

In some embodiments, the alert is different in different parts of the site.

In some embodiments, the alert may also be sent as a message via a cellular communications system, for example, as an SMS message or audible announcement to a remote site supervisor.

In some embodiments, this could be a displayed message on a monitor, an announcement or warning siren alerting the site or just the site in the vicinity of the unexpected object or a message to a site overseer or some other suitable form of alert.

In some embodiments, the site comprises the AOZ, but in some embodiments a site comprises a number of different AOZs.

According to a second aspect of the disclosed technology, an object location correlating system (26) comprises memory, one or more processors or processing circuitry, and computer-program code stored in the memory, which, when loaded from the memory and executed by the one or more processors or processing circuitry causes the object location correlating system to perform a method according to the first aspect and/or one or more of its embodiments.

In some embodiments. the object location correlating system comprise a remote unit configured to monitor an AOZ.

In some embodiments, the object location correlating system comprises a vehicle operating in the AOZ.

According to a third aspect of the disclosed technology, a vehicle configured to operate in an autonomous operating zone, AOZ comprises an automated driving system, ADS, a control system, and a wireless communications capability, where the control system is configured, responsive to the ADS (22) detecting an object, to generate object position information comprising information from which an ego-position of the vehicle and a relative position and/or pose of the object to the vehicle can be determined, and cause the object position information to be sent over a wireless communications link using the wireless communications capability of the vehicle to an object location correlating system according to the second aspect and/or any of its embodiments.

According to a third aspect of the disclosed technology, the control system is configured, responsive to the ADS detecting an object, to generate information from which a position of the vehicle and the relative position of a detected object to the vehicle can be determined, and to cause the information to be sent over a wireless communications link to an object location correlating system according to the second aspect or any of its embodiments.

Another, fourth, aspect of the disclosed technology relates to a computer-readable storage medium comprising computer-program code which, when executed by one or more processors or processing circuitry of an apparatus, causes the apparatus to implement a method according to the first aspect or any of its embodiments and/or any other method disclosed herein.

Another, fifth, aspect of the disclosed technology relates to a computer-program carrier carrying a computer-program comprising computer-program code, which, when loaded from the computer-program carrier and executed by one or more processors or processing circuitry of an apparatus causes the apparatus to implement a method according to the first aspect or any of its disclosed embodiments and/or any other method disclosed herein, wherein the computer-program carrier is one of an electronic signal, optical signal, radio signal or computer-readable storage medium.

Another, sixth aspect of the disclosed technology comprises a control system or circuitry for a vehicle having an automated driving system, ADS, the control system or circuitry comprising memory, one or more processors or processing circuitry, and computer-program code which, when loaded from memory and executed by the one or more processors causes the control system to implement a method according the first aspect or any disclosed embodiments and/or of any other method disclosed herein.

A seventh aspect of the disclosed technology comprises an apparatus comprising a memory, one or more processors or processing circuitry, and computer-program code, wherein the computer-program code, when loaded from memory and executed by the one or more processors or processing circuitry, causes the apparatus to implement a method according to the first aspect or any one of the disclosed embodiments of the first aspect and/or any other method disclosed herein. The apparatus further comprises all necessary functionality to implement the method according to the first aspect or any one of the disclosed embodiments of the first aspect and/or any other method disclosed herein, for example, hardware and/or software, which may be provided in a module form, may be used. Examples of hardware which may be required to implement the invention include transmitters and/or receivers to receive reports using one or more wireless communications protocols. Another example, of hardware and software which the apparatus may include comprises a user or data interface.

Another, eighth aspect of the disclosed technology comprises a computer-program product configured to be used by a device mounted on or integrated in a vehicle having an automated driving system, wherein the computer-program product comprises computer-code which when loaded from memory and executed by one or more processors or processing circuitry of a control system of the vehicle, causes the vehicle to implement a method according to the first aspect or any of its disclosed embodiments and/or any other method disclosed herein.

In some embodiments the computer-program product comprises computer-program code and/or modules configured when loaded and executed by one or more processors or processing circuitry on an apparatus, for example, an apparatus according to the seventh aspect or any suitable disclosed apparatus, causes the apparatus to implement a method according to the first aspect or any one of the disclosed embodiments of the first aspect and/or any other method disclosed herein.

In some embodiments of the disclosed technology, for example, in the above fourth to eight aspects, the computer code is implemented by one or more modules, where each module is comprises computer code configured to implement one or more of the steps of one or more of the disclosed method aspects or any of their embodiments.

### BRIEF DESCRIPTION OF THE DRAWINGS

Some embodiments of the disclosed technology are described later below in relation to the accompanying drawings which are by way of example only and in which:

FIG. 1A is a schematic view of an example autonomous vehicle operating zone at a first point in time according to some embodiments of the disclosed technology;

FIG. 1B is a schematic view of the example autonomous vehicle operating zone of FIG. 1A at a later point in time;

FIG. 2 is a schematic view illustrating how an example system for collaboratively monitoring an autonomous vehicle operation zone according to some embodiments of the disclosed technology;

FIG. 3A illustrates schematically a method performed by a vehicle in a monitored AOZ according to some embodiments of the disclosed technology;

FIG. 3B illustrates schematically a method of monitoring an AOZ according to some embodiments of the disclosed technology;

FIG. 3C illustrates in more detail an example method of monitoring an AOZ according to some embodiments of the disclosed technology; and

FIGS. 4A to 4C illustrate schematically various configurations of an AOZ monitoring system according to some embodiments of the disclosed technology.

### DETAILED DESCRIPTION OF EMBODIMENTS

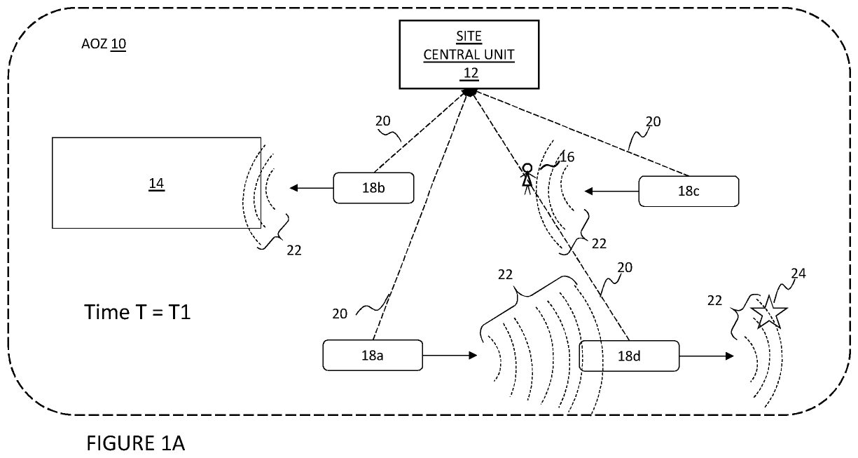

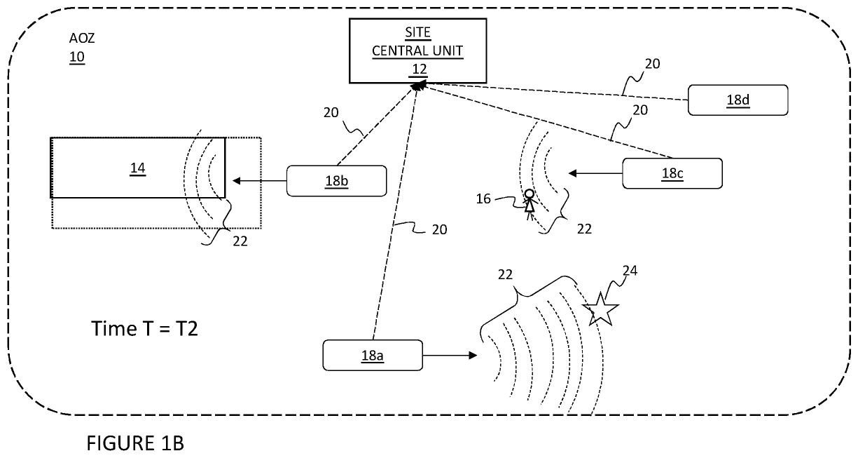

FIG. 1A is a schematic overhead view of an autonomous operating zone, AOZ, 10 in which a method of monitoring is implemented according to some embodiments of the disclosed technology, for example, a computer implemented method 100 for monitoring an autonomous operating zone, AOZ, 10 including a number of one or more autonomous vehicles 18a-18d, each vehicle having sensors arranged to detect an ego-position of the vehicle and relative positions of surrounding objects 14, 16, 18, the method is performed by an object location correlating entity, which may be a site central unit or platform 12 or at another vehicle 18a-18d from the vehicle detecting the object which is also operating in the AOZ 18. The method of monitoring comprises firstly receiving, in real-time in other words live, data from an autonomous vehicle operating in the AOZ. The real-time data comprises a report including an ego-position of the vehicle, one or more positions and/or poses of objects detected by the vehicle and responsive to the object location correlating entity receiving the report, entity determines a detected object location for each detected object based on the reported vehicle ego-position and reported detected object position relative to the vehicle ego-position, a correlation for each determined object location with one or more expected object locations in the AOZ, and based on the correlation, determines if the object is an expected object or unexpected object at the determined object location according to whether the correlation meeting a correlation condition. If the condition is met, in other words, if the two locations are sufficiently close to each other, for example, within a couple of meters or so depending on the size of the size, the object may be classified either as an unexpected object per se or as an unexpected object at that location.

In the example scenario depicted in FIG. 1A, at an example point in time T=T1, a number of objects 14, 16, 18, 20 are within the AOZ 10. Examples of the objects which may be found within an AOZ 10 include stationary objects 14, such as, for example, large rocks or earthworks, stationary vehicles or vehicle accessories such as trailers, and buildings. Also shown in FIG. 1A are moving objects 16, 18, for example, a pedestrian, 16, and other vehicles 18, for example, vehicles 18a, 18b, 18c, and 18d as in FIG. 1A. Also shown in FIG. 1A is another object 24 which is unexpected.

The AOZ 10 shown in the example scenario of FIG. 1 may be illustrative of a closed site, for example, a mining site, a building site, a manufacturing site or factory, an airport, or similar site, or an open site, for example, a public area or site or road.

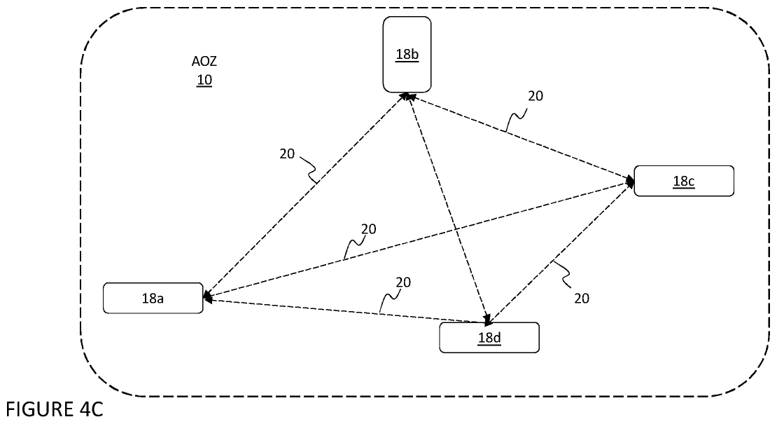

Each of the vehicles 18a-18d is configured to send information about objects it detects to an object correlating entity which determines the location of detected objects and then correlates the determined locations with known locations to determine if the detected object is an object expected at the detected location or not. FIGS. 4A to 4C described in more detail herein below give various examples of object correlating entity configurations for a AOZ 10. As shown in FIG. 1A, however, the object locating entity is the site central unit 12 to which each vehicle 18a-18b sends information about its own ego-position and also information about any objects it detects using its sensor system 22. As shown in FIG. 1A, the sensor system's s forward facing sensors only are sketched for simplicity but it will be apparent to anyone of ordinary skill in the art that a sensor system additionally including one or more rear and/or side object-sensing sensors could also be used in some embodiments.

As shown in FIG. 1A, vehicle 18a has particularly long range sensors, but in some embodiments all of the vehicles may have the same type of sensor systems 22. As shown in FIG. 1A, vehicle 18a has detected another vehicle 18d, vehicle 18b has detected object labelled 14, which in this example scenario comprises a stationary object. Vehicle 18c has detected a moving object 16 in this case a pedestrian. Vehicle 18d has detected an object 24 using its sensors which when reported to the site central unit 12 which is configured to perform a method of monitoring an AOZ 10 according to the disclosed technology is determined by the site central unit 12 to be an unexpected object 24 at that location and at time T=T1.

FIG. 1B shows how at a later point in time T=T2, the vehicles 18a-18d have all moved and now 18b has noticed a change in the configuration of static object 14, vehicle 18c has noticed the pedestrian's location has moved, and vehicle 18d is no longer detecting any objects within the AOZ, and vehicle 18a is now detecting the object previously reported by vehicle 18d.

Each vehicle 18a-18d in the AOZ 10 is only aware of its own ego-position when it detects an object and the relative position of that object to the vehicle, information may be generated either on the vehicle or remotely to allow comparison of the actual location of the object detected to be determined. In some embodiments, a vehicle such as vehicle 18a will also collect information representing one or more characteristics of the detected object. For example, information representing one or more of the following characteristics: size, configuration, trajectory, pose, behaviour may be provided with information with and the detected location of the object.

In some embodiments, the information about the object is sent to a remote platform 36, for example, a central unit for the site 12 as shown in FIGS. 1A to 1B and 4A. The remote platform may be a distributed platform 12a,12b, 12c as shown in FIG. 4B in some embodiments. In some embodiments, instead or in addition, the vehicles 18a-18b may share information about the objects they have detected with other vehicles 18a-18d in the AOZ 10, see FIG. 4C for example.

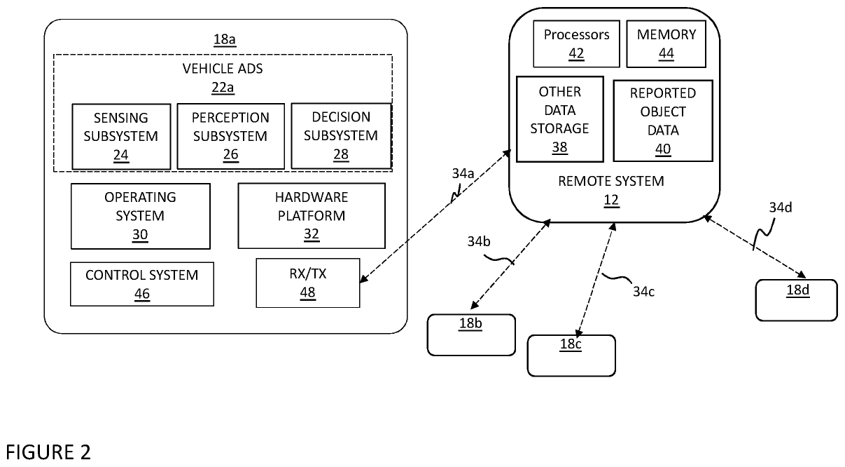

The information may be processed to determine if an object is an expected object at an expected location by comparing the information received from one or more vehicles with contemporaneous information received from other vehicles of object they have detected and/or with stored information. For example, in some embodiments a data-base of expected object locations, and/or previously determined locations of unexpected objects may be stored in a reported object data store 40 on remote system 12, for example, on a central unit 12 for the site as shown in FIG. 2. The reported object information can be correlated with information reported from one or more other vehicles 18a-18d in the vicinity either contemporaneously or at a later point in time to determine if a detected object is an expected object at its determined location or if it is an unexpected object at that location. In addition, if a vehicle has detected an unexpected object at a particular location of the AOZ, if one or more other vehicles report information which indicates they have also detected an unexpected object at the same location, there can be more confidence that the unexpected object actually exists at that location rather than the unexpected object being a false detection of something by the ADS 22 of just one vehicle 18.

In this way, by comparing information representing the positions of the one or more objects detected by the plurality of vehicles in an AOZ with information representing one or more positions associated with one or more expected objects in the AOZ which are known to the central unit, it is possible to distinguish false detections by a single ADS of a vehicle from unexpected objects that multiple vehicles have detected. For example, in the scenario shown in FIG. 1A, when vehicle 18a reports the object it has detected to the central unit 12, the central unit can disregard that object as unexpected as it is aware of the location of vehicle 18d and is able to correlate the object reported by vehicle 18a with the location of vehicle 18d at the time vehicle 18a detected the object. Similarly, in some situations, the central unit may disregard reports of objects which are within certain geofenced areas. For example, vehicle 18b reported object 14 at time T=T1, however, the central unit 12 may be aware that the location it determines object 14 to be at is within an excluded zone, for example, object 14 may be a large rock that is being mined, so that although static, its configuration changes over time. By ignoring the location where the rock is, resources are conserved in a more energy efficient manner by preventing unnecessary processing of the object detection data at the central unit 12.

In addition to finding unexpected objects, it is possible in some embodiments, by analyzing historical information, to track object behaviour as well, and so it is possible in some embodiments to determine if the behaviour of a detected object is expected behaviour or unexpected behaviour. For example, comparing FIG. 1A with FIG. 1B, the unexpected object 24 seen by the vehicles 18d and later 18a could be a vehicle which is known to be on the site but which has broken down. In this sort of scenario, and in other situations where an unexpected object or object behaviour is determined on the site, the central unit may generate an alarm to alert operators on the site and/or to take some other action, such as to send a maintenance request for the broken-down vehicle so that it can be repaired.

More generally, actions which may be taken in some embodiments when an unexpected object is detected may depend on the use case and on the detected anomaly and/or type of unexpected object or behaviour. Examples of actions include: alerting an operator, shutting down all ADS on the site/AOZ, requesting repair/maintenance/towing of the object detected, shutting down the detected object if it is still controllable, limiting operation (e.g. reducing any limit speeds) either in entire site or in the specific zone where the anomaly/unexpected object/unexpected behaviour was discovered, restricting operation in entire site or specific zone to only allow ADS with a certain subset of functionality implemented (e.g. obstacle detection systems with a certain integrity), and/or in some situations closing down a certain area/zone in the site in the vicinity of the detected unexpected object/behaviour and re-planning all operations to use other parts of the site (e.g. by planning missions/paths which does not enter the relevant zone) and deploying the updated plans to all other (especially other autonomous) vehicles operating on the site which might otherwise be affected by/encounter/collide with the unexpected object.

Turning now to FIG. 2, this is a schematic view of an example system for performing a method of monitoring an AOZ such as the example AOZ 10 of FIGS. 1A and 1B. As shown schematically in FIG. 2, a number of autonomous vehicles 18, such as the vehicles 18a-18d shown in FIGS. 1A and 1B are configured to communicate with a remote system shown as remote platform 12 in FIG. 2 which may comprise a central unit such as was shown as central unit 12 in FIGS. 1A and 1B.

As shown, each of the vehicles 18a-18d is configured with an automated driving system, ADS 22, in the example system of FIG. 2. One or more or all of the vehicles 18a-18d may be an autonomous vehicle to some degree in some embodiments of the system shown in FIG. 2, however, it is also possible for one or more or all of the vehicles 18a-18d to be remotely operated, or to some greater or lesser degree manually operated vehicles provided with an ADS 22 in some embodiments.

As illustrated in FIG. 2, vehicle 18a-18d in the AOZ 10 comprises an ADS 22, of which only ADS 22a is shown in any detail. ADS 22a comprises sensing, perception and decision subsystems or modules 24, 26, 28 which run on the vehicle operating system 30 and hardware 32. Each vehicle is also configured with a control system 46 and a communications module, shown as RX/TX 48 in FIG. 2. This allows the vehicle to communicate over one or more communication links 34a, 34b, 34c, 34d with other vehicles (not shown in FIG. 2, see FIG. 4C) and/or with a remote system such as a central unit or back office 12. Each vehicle may use the same or different communications links, for example, a Wi-Fi, cellular or satellite communication link, may be used to establish communications between the vehicle and remote system 12. In some embodiments, one or more of the vehicles 18a-18d may also include as software and/or hardware/processing circuitry computer-program code to configure the vehicle as an object location correlating entity so that the vehicle can implement a method of monitoring an autonomous operating zone, AOZ, or at least the AO in its vicinity according to any of the disclosed aspects or embodiments of the methods 50 and/or 60 and/or 100.

The remote system 12 configured to store data representing expected objects in a data store or memory, shown as expected object data store 40 in FIG. 1. It may also be provided with one or more other forms of memory for storing other forms of data, such as map and/or ADS updates, shown in FIG. 2 as other data store 38. The remote system 12 is also provided with one or more processors 42 and memory 44 to store received data from vehicles 18a-18f for processing to determine the position of any received objects in the AOZ and then to perform a lookup or similar operation to determine if the objects are known (as in expected) objects at that location by querying the locations determined for objects in report by other vehicles 18a, 18c, 18d in the vicinity of the detected object. Also, the central unit will be aware of what moving objects such as the other vehicles 18a-18d could be located at the location where one of the vehicle has detected an object. In some embodiments, the remote system 12 may also check stored information which indicates if detected objects have been previously reported at a particular location at the same time or at the same time on a different day/week etc. in a data store 40. If an object detected at a particular location in the AOZ 10 is not an expected object, its location accordingly may also be stored in data store 38 in some embodiments so that it can compared with other reports of objects at that location from other vehicles of unexpected objects. If more than one vehicle reports the same object whose location is determined to not be a location of an object known to the remote system, shown as central unit 12 in FIG. 1, it is more likely that the object is a real object unexpectedly at that location than if just one vehicle reports an object at that location. Similarly, if the same vehicle repeatedly reports an unexpected object at a particular location that may also increase the confidence level that the object is a real object at an unexpected location rather than being a false object detection.

The remote system 12 (shown as central unit 12 in FIGS. 1A and 1B) may also include as software and/or hardware/processing circuitry computer-program code which when executed configures the remote system 12 as an object location correlating entity so that the system 12 can implement a method 60, 100 of monitoring an autonomous operating zone, AOZ, according to any of the disclosed aspects or embodiments of the methods 60 and/or 100.

In order for the remote system 12 to be able to determine consistently the locations of objects, each of the vehicles 18a-d in the AOZ 10, will for each of any surrounding objects detected by the ADS 22 of that vehicle, send to the remote system 12 the position of any objects that the vehicle has detected relative to the ego position of that vehicle along with its own ego position. It is also possible, however, in some embodiments for the vehicles to share such information amongst themselves in a peer-to-peer network such as that shown in FIG. 4C (described in more detail later below), providing at least one vehicle is capable of determining using a consistent coordinate system the location of detected objects in the AOZ so that comparisons can be performed with known object locations.

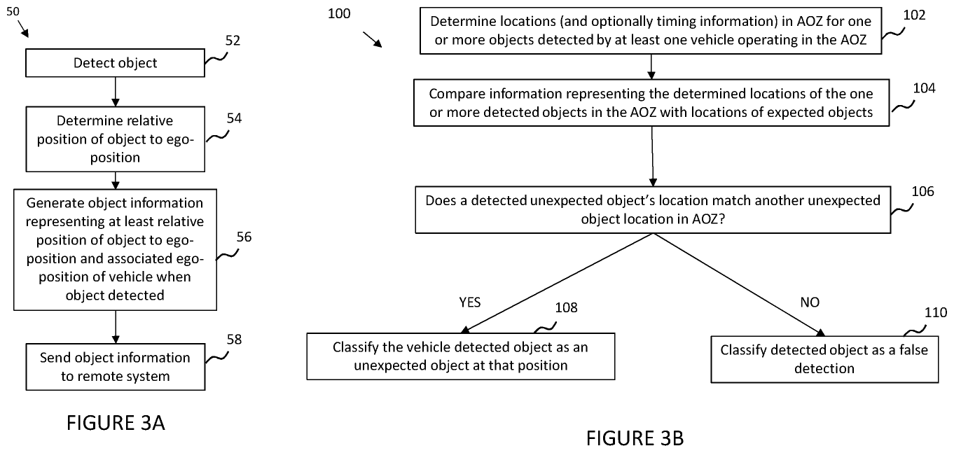

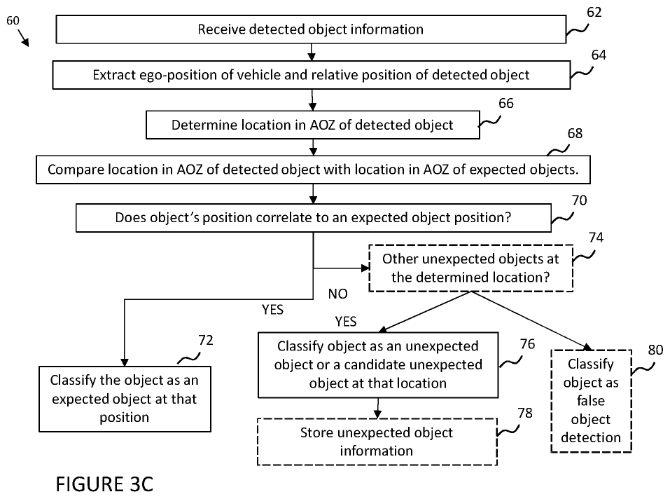

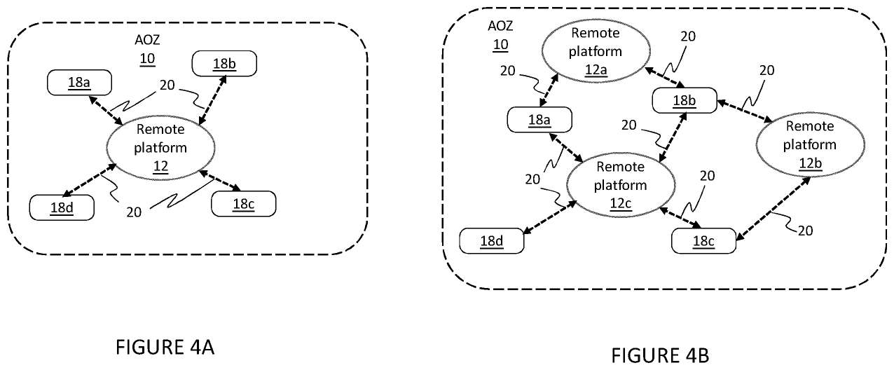

FIG. 3A illustrates schematically a method 50 performed by a vehicle 18 in a collaboratively monitored AOZ 10 according to some embodiments of the disclosed technology, in which, when the vehicle detects 50 an object, the relative position of the object to the ego-position of that vehicle 18 is determined 54. The vehicle then generates 56 information representing at least the relative position of the object to the ego-position of the vehicle, and reports its ego-position as well, and sends 58 the generated position information for itself and the object(s) it has detected to a remote system 12, which acts as an object location correlating entity and performs a method of monitoring the AOZ 10 using the received information according to the disclosed technology. The information is sent in real near-time. As the amount of object information may be considerable, in some embodiments the vehicle may perform a filter operation prior to sending the information to the object location correlating entity which is implementing the monitoring of the AOZ, e.g. the central unit or remote system 12.

In other words, the vehicle transmits both its own position and any detected object position (absolute or relative). Each vehicle sends its ego vehicle position to the remote system 12 so that this can track where it is, since that will also be a current position of an expected (moving) object. Any object reported from another vehicle needs to be compared to the set of received (expected) ego vehicle positions as well as positions of (expected) static objects from a database or similar data store.

FIG. 3B illustrates an example of a method 100 which the object location correlating entity, for example, a remote system 12 such as a central unit 12 for the AOZ to monitor and/or by one or more other vehicles 18a-18d in the AOZ, performs to collaboratively monitor the AOZ according to some embodiments of the disclosed technology.

Some embodiments of the computer-implemented method 100 compare object detections and their determined location information where the objects have been reported by different vehicles, and as such, may be considered to implement a collaborative monitoring of the an autonomous operation zone (10). The monitoring, for example, the collaborative monitoring, method shown in FIG. 3B, may also be considered to be collaborative as the vehicle is sharing object locations with the remote system such as the central unit 12. The method of monitoring or collaboratively monitoring 100 comprises determining 102 locations for one or more objects detected by each of one or more vehicles 18a-18d in the autonomous operation zone, based on a determined position of each object, 14, 16,18a-18d, 20 detected by one or more of the vehicles relative to the ego position of each detecting vehicle 18a-18d and the ego-position of the detecting vehicle; and comparing 104 information representing at least one location of the object in the AOZ with information representing one or more locations associated with one or more expected objects, 14, 16,18a-18d in the AOZ 10.8 Where reference is made to storing object location information, this may be transiently stored for some types of moving objects. For example, positions for moving expected vehicles will typically not be stored for a long time as their position will be reported in each time step and stored only for that time step before they are discarded. In this case, the method must process the moving object detections in that time-step to determine if they are vehicle detections.

The method may further comprise determining the detected object, 14, 16,18a-18d, 20 is an unexpected object 20 or is a candidate unexpected object 20 at its detected position based on the comparison by the remote unit 12 indicating that at least two vehicles of the plurality of vehicles 18a-18d has detected an unexpected object at the same position in the autonomous operation zone 10, in which case the monitoring is a collaborative monitoring.

FIG. 3C illustrates schematically a more detailed example of a method 60 performed by a remote system such as a central unit 12 when performing a method of monitoring an AOZ 10 according to some embodiments of the disclosed technology. In FIG. 3C, the remote system or central unit 12 receives 62 detected object information from a vehicle and processes 64 the received information to extract the ego-position of the vehicle and the relative position of the detected object in order to determine 66 the location of the detected object in the AOZ 10. Once the location of the detected object in the AOZ has been determined, it is compared 68 with the location in the AOZ of expected objects, for example, by performing a look-up operation based on the object location with stored or buffered locations of known objects in the AOZ. Such a look-up may be implemented by checking the current positions of all expected moving vehicles in the AOZ, either based on their reported data or on their predicted positions at the time the object was detected by the reporting vehicle. If the detected object's location matches an expected object at that location, the object is classified 72 as an expected object at that location.

If not, then in some embodiments, a check is performed to see if there are other unexpected object detections at the determined location 74. If they are, then the object is classified 76 as an unexpected object at that location directly. However, in embodiments where an unexpected object data store is maintained, the object location and other information about the object is stored 78 in an unexpected object data store. In addition, when information about previously detected unexpected objects is stored in an unexpected object data store, for example, a database or the like, such as that shown as data store 40 in FIG. 2, then before or after classifying 76 the object as an unexpected object, the object's location in the AOZ may be checked against existing records of unexpected objects at the same location. If there is a match, then the unexpected object may be classified with more confidence as an unexpected object in some embodiments. In some embodiments however, if there is only one report of an unexpected object at a location, i.e. there are no other existing reports in the unexpected object database found within a certain time-span of the time associated with the detected object, the detected object is classified 80 instead as a false detection.

The unexpected object 20 may be detected as either a stationary or a moving object.

In some embodiments, if the object is a moving object, then the method may further include determining a behaviour of the moving object by tracking at least the movements of the object in the AOZ and comparing the determined behaviour of the moving object with one or more expected behaviours of expected objects in the AOZ. If the determined behaviour does not match the behaviour of an expected object in the AOZ, the detected object may be classified as an object having unexpected behaviour and/or as an unexpected object.

In some embodiments, the behaviour is determined based on timing information for when each object was detected by the vehicle which is reported by the vehicle. Alternatively, in some embodiments, timing information for when each object was detected by the vehicle is determined by the object location correlating entity based on a time when the real-time data report including the detected object was received by the correlating entity.

The comparison of tracked behaviour of an object in some embodiments uses stored information which represents behaviours of known actors, in other words, other moving expected objects, in the AOZ, such as vehicles. A pedestrian or site operative is an example of a moving object which, if identifiable through a tag or similar tracking device, could have their movements monitored to determine certain behaviours determined and stored.

Another example of a known actor may be a moving object is a vehicle, which may be fully or partially autonomous. Some or all of the autonomous behaviour, for example, a trajectory of the vehicle or its pose at any particular point on a trajectory, may be predefined. If so, then the stored behaviour may be predefined behaviour linked to behaviours of vehicles associated with the AOZ 10. For example, if several vehicles detect a moving object which appears to be an autonomous vehicle such as a dumper truck at a location which is on the trajectory of an autonomous vehicle such as a fork-lift truck or the like, the moving object may be considered an unexpected object as it is not fork-lift truck but is a dumper truck. Similarly, on the trajectory of the fork-lift truck, if one or more vehicles detected a rapidly spinning object at a location where the fork-lift truck should have been, the rapidly spinning object may still be determined to be an unexpected object, as it is an object with unexpected behaviour at that location. Similarly if the pose of an object is also unexpected, this may also trigger the detected object to be treated as if it was an unexpected object at its determined location.

In some embodiments, according, the AOZ 10 is a closed AOZ associated with a group of one or more vehicles 18a-18d, which form a group of expected moving objects within the AOZ. Accordingly, in some embodiments, information about trajectories of moving objects such as vehicles 18a-18d within an AOZ and/or behaviours of moving objects such as vehicles 18a-18d in the AOZ is stored, for example, on a remote system 12 such as the central unit shown in FIGS. 1A and 1B or as shown in FIG. 2, 4A or 4B so it can be compared with detected positions and detected behaviours of detected objects in order to classify the detected objects as expected objects within the AOZ.

In some embodiments, the determining 102 is by each of a plurality of vehicles in the AOZ, positions for one or more surrounding objects detected by that vehicle relative to the ego position of that vehicle comprises detecting, by the plurality of vehicles, one or more objects in the area, and determining, by each vehicle of the plurality of vehicles an ego-position of that vehicle and a relative position of each object detected by a vehicle to the ego-position of that vehicle.

In some embodiments, determining if any of the vehicle detected objects, 14, 16, 18, 20 are unexpected objects 20 comprises determining a position of each vehicle detected object in a coordinate system used to record positions of expected objects and attempting to match 106 the position of each vehicle detected object in the coordinate system with a stored position associated with an expected object in the AOZ 10. If the position of a vehicle detected object, 14, 16, 18, 20 can be matched to a stored position associated with an expected object 14, 16, 18 in the AOZ 10, then that one object is classified 108 as an expected detected object in the AOZ 10. If the position of at least one vehicle detected object 14, 16, 18, 20 cannot be matched to a stored position associated with an expected object 14, 16, 18, in the AOZ, then the at least one object is classified 110 as an unexpected vehicle detected object 20 in the AOZ in some embodiments. In some embodiments, the type of object detected may also be classified, and based on the object type classification, the monitoring of that object may be terminated in some embodiments.

FIG. 4A illustrates schematically an example embodiment of a system for shown in FIG. 2 in which a plurality of vehicles 18a-d in an AOZ are configured to send information on detected objects to the same remote system 12. FIG. 4B illustrates schematically an example embodiment of a system 10 for collaboratively monitoring an AOZ such as that shown in FIG. 1 in which the plurality of vehicles 18a-d in the AOZ are configured to send information on detected objects instead or in addition to different remote systems 12a,12b, 12c. For the algorithm to work properly, the remote system should preferably get information about all expected vehicles position. If 18a-d are expected, each remote platform should have the information about their current position. By way of example, if not, then a reported detection from, 18a of 18b could be classified as an unexpected vehicle since the remote system does not have information about the position of 18b and cannot relate the detection to it.

In FIGS. 4A and 4B, each of the plurality of vehicles 18a-d is configured to report information representing the ego-positions of the plurality of vehicles 18a-d and the relative positions of each of the vehicle detected objects 14, 16, 18a-d, 20 by the plurality of vehicles 18a-d to a remote system 12 for example, a central unit of the AOZ 10. The remote system 12 (either as a stand-alone platform or as a distribute system then uses the information received from each vehicle in the AOZ to determine, based on the information representing the ego-positions of the plurality of vehicles and the relative positions of each of the vehicle detected objects by the plurality of vehicles, if any of the detected objects are unexpected objects. The remote system 12 may then send an indication of whether an object detected by one or more of the vehicles 18a-d in the AOZ is an unexpected object so that the ADS of the vehicle can take appropriate action.

The remote system 12 is shown as a single remote system 12 in FIG. 4A and as a plurality of remote platforms 36a,b,c which may form a distributed system, for example, a cloud-based system, in FIG. 4B. It is also possible for the vehicles 18a-18d to share information with each other as FIG. 4C illustrates. The system of FIG. 4C may be implemented in addition to, or as an alternative embodiment of, the systems shown in FIGS. 4A and 4B.

For example, in some embodiments of the system shown in FIG. 4C, each of the vehicles 18a-18d is further configured to share information representing its ego-position and the relative positions of each object detected by that vehicle with other vehicles 18a-d of the plurality of vehicles in the autonomous operation zone. At least one vehicle can then determine if an object it has detected is an unexpected object based on the shared information by determining a position of each of the plurality of vehicle detected objects detected by the plurality of vehicles in a coordinate system used to record positions of expected objects, and, if the position of at least one vehicle detected object of the plurality of vehicle detected objects in that coordinate system objects cannot be matched to a reference location for an expected object in that coordinate system, determining the at least one object is an unexpected vehicle detected object.

Returning to FIG. 3, in some embodiments of the method 100, the information representing the position of an object includes information representing one or more movement characteristics of the object. The method 100 may then further comprise monitoring the position and movement characteristics of the object over a period of time based on the information, and determining a behaviour of the moving object based on the monitored position and movement characteristics.

In some embodiments, determining if the detected behaviour comprises unexpected behaviour of the object in the area by comparing the detected behaviour with a stored behaviour pattern.

In some embodiments, the method 100 further comprises determining a confidence score for a detected object determined to be an unexpected object 20. The confidence score may increase depending on the number of vehicles 18a-d in the AOZ that also detect an unexpected object 20 at the same location. For example, if two or more vehicles detect an object which is unexpected at a particular location it is more likely to be a real object detection than a false positive detection.

The remote systems shown in FIGS. 4A, 4B, and in FIG. 2, may, in some embodiments of the disclosed technology, take the form of a system configured to perform a method of monitoring an AOZ, for example, a method according to the disclosed embodiments, in which unexpected actors can be detected by a central unit acting as an object location correlating entity in the AOZ. Such a system 12 may comprises one or more, but preferably a plurality of autonomous vehicles 18a-18d operating at the same time in the AOZ 10. Each vehicle 18a-18d is configured to detect, in the AOZ 10, positions for one or more objects 14, 16, 18, 24 which may include expected objects or unexpected objects at the determined locations of the objects. The positions are detected by that vehicle relative to the ego position of that vehicle and the location of the detected objects is preferably determined by a remote central unit 12 configured to receive object detections and location information for all moving actors in the AOZ as well as having access to location data for static objects in the AOZ. The system includes at least one processor or processing circuitry, computer-program code held in memory, and is configured so that when the computer-program code is loaded from memory and executed by the at least one processor or processing circuitry, it executes a method of monitoring the AOZ according to the disclosed embodiments. For example, in some embodiments, the at least one processor or processing circuitry is configured to determine if at least one detected object is an unexpected object, by first determining the detected objects location (i.e. its geographic location rather than its location relative to the detecting vehicle) and then by comparing information representing the locations of the one or more detected objects with information representing one or more stored positions associated with one or more expected objects in the autonomous operation zone.

In some embodiments, the processing system comprises one or more remote systems, for example, the remote systems shown schematically as remote system 12 in FIGS. 2 and 4A, and for example, the remote systems 12a,b,c in FIG. 4C, where the remote system is implemented as a distributed system. In some embodiments, the information about an object that a vehicle detects, for example, vehicle 18a, may be instead or in addition shared directly with other vehicles, for example, vehicles 18b-d, in the AOZ, as FIG. 4B illustrates schematically.

In some embodiments, accordingly, the distributed system comprises one or more of the other vehicles of the plurality of vehicles. If position information on other vehicles is made available to a vehicle, then in some embodiments, each of the plurality of vehicles 18a-d is configured to report information representing their position and a position of one or more of the plurality of other vehicles form whom they receive information on detected objects. In this case the relative positions of one or more detected objects may be determined by the vehicle receiving the information can compared to their own detection of the position of an unexpected object, and/or the information may be shared with at least one of the one or more remote systems 36. However, to implement a distributed peer-to-peer network such as that shown in FIG. 4C, each vehicle 18a-18d in the network must be capable of comparing the position of an object it has detected with the positions of expected objects.

In some embodiments where each of the plurality of vehicles is configured to report information representing its ego-position and a relative positions of each detected object to a the remotes system, the remote platform performs the determining, based on information representing the ego-positions of the plurality of vehicles and the relative positions of each of the detected objects by the plurality of vehicles, if any of the detected objects are unexpected objects.

In some embodiments of the above disclosed systems and methods, each vehicle of the plurality of vehicles 18a-d in the AOZ 10 is configured to monitor a detected object in the area over a period of time, detect a behaviour of the object in the area in the period of time, and determine if the detected behaviour comprises unexpected behaviour of the object in the area by comparing the detected behaviour with a stored behaviour pattern.

In addition to merely detecting an object, in some embodiments of the disclosed technology, a remote system 12 may receive sufficient information from a vehicle for it to analyze each detected object to identity a classification of the object.

In some embodiments, the remote system 12 shown as remote system 12 in FIGS. 2 and 4 for example, may be configured to determine a confidence score for each detected object determined to be an unexpected object based on the detected location of the unexpected object. The confidence score for a detected object reported by a vehicle 18a-18d being determined as an unexpected object may increase depending on the number of vehicles 18a-18d that report objects which are determined to be unexpected object at the same location.

Whilst the above embodiments have described a closed AOZ, it is possible in some embodiments for the AOZ to be an open or closed site, and even possibly a public road.

As mentioned above, some or all of the plurality of vehicles 18a-18d in the AOZ may be a plurality of autonomous or semi-autonomous vehicles in some embodiments of the disclosed technology.

The examples of the remote system 12 shown in FIG. 2 (and also in FIGS. 4A and 4B) comprise in some embodiments, one or more processors 42, memory 44, and computer-program code, wherein the computer-program code is configured to, when loaded from memory 44 and executed by the processors 42, cause the system to perform one or more or all of the disclosed embodiments of method 100 disclosed herein for collaboratively monitoring an AOZ 10.

Another aspect of the disclosed technology relates to a control system 46 for an vehicle 18 having an ADS 22, for example, a control system shown as control system 46 of vehicle 18 in FIG. 2 of the accompanying drawings and described herein above. In some embodiments, the control system is configured, responsive to the ADS 22 of the vehicle detecting an object, to generate information from which a position of the vehicle 18 and the relative position of the object to the vehicle 18 can be determined and to cause the information to be sent over a wireless communications link to a system such as the remote systems 36 or 36a,b,c described h herein above and as shown in FIG. 2, and FIGS. 4A and 4B of the accompanying drawings.

Another aspect of the disclosed technology relate to a vehicle (18) comprising an advanced driving system, ADS, such as the ADS 22 shown in FIG. 2. The vehicle also includes a control system 46 a wireless communications capability 48, as well as an operating system and other hardware, which may take the form of circuitry to implement the ADS and the control system.

In some embodiments, the control system 46 is configured, responsive to the ADS 22 detecting an object, to generate information from which a position of the vehicle 18 and the relative position of the object, 14, 16, 18, 20 to the vehicle 18 can be determined, and cause the information to be sent over a wireless communications link using the wireless communications capability of the vehicle to a system, such as the remote systems shown in FIGS. 2, 4A and 4C.

The advanced driving system, ADS 22, comprises suitably configured sensing, perception, and decision subsystems 24, 26, 28 so that the vehicle can detect objects in its vicinity, using, for example, line of sight techniques based on depth perception as well as radar and the like. In addition, the ADS 22 includes or is configured to interface with the control system 46 for the vehicle and/or a wireless communications module, shown as RX/TX module 48 in FIG. 2, so that it can communicate with remote system 12 and/or other parties, for example, other vehicles in the AOZ.

In some embodiments, the control system 46 is configured, responsive an object being detected, for example, by the sensing and perception modules 24, 26 of the ADS, to generate a message or other suitable form of data communication which includes information from which the vehicle position and the relative position of the object to the vehicle can be determined by a remote system 12, and to cause the message or other form of data communication including the information to be sent over wireless communications link 34 (examples of wireless link 34 are shown as wireless links 34a, 34b, 34c, and 34c in FIG. 2) to a remote system 12 and/or to any other vehicles which have the capability to compare positions of objects detected by other vehicles.

Various elements of the disclosed technology could be modified. For example, in some embodiments the remote system 12 may comprises a central unit configured to remotely manage and/or update the ADSs 22 of each of the vehicles in the fleet of vehicles authorized to operate in the OZA 10. Many other such modifications are possible and could be made within the scope of the inventive concepts.

Where the disclosed technology is described with reference to drawings in the form of block diagrams and/or flowcharts, it is understood that several entities in the drawings, e.g., blocks of the block diagrams, and also combinations of entities in the drawings, can be implemented by computer-program instructions, which instructions can be stored in a computer-readable memory, and also loaded onto a computer or other programmable data processing apparatus. Such computer-program instructions can be provided to a processor of a general purpose computer, a special purpose computer and/or other programmable data processing apparatus to produce a machine, such that the instructions, which execute via the processor of the computer and/or other programmable data processing apparatus, create means for implementing the functions/acts specified in the block diagrams and/or flowchart block or blocks.

In some implementations and according to some aspects of the disclosure, the functions or steps noted in the blocks can occur out of the order noted in the operational illustrations. For example, two blocks shown in succession can in fact be executed substantially concurrently or the blocks can sometimes be executed in the reverse order, depending upon the functionality/acts involved. Also, the functions or steps noted in the blocks can according to some aspects of the disclosure be executed continuously in a loop.

In the drawings and specification, there have been disclosed exemplary aspects and embodiments of the disclosed technology. However, many variations and modifications can be made to these aspects without substantially departing from the principles of the present disclosed technology. Thus, the disclosed technology should be regarded as illustrative rather than restrictive, and not as being limited to the particular aspects discussed above.

The description of the example embodiments provided herein have been presented for purposes of illustration. The description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of methods, apparatus, modules, systems, and computer-program products. It should be appreciated that the example embodiments presented herein may be practiced in any combination with each other.

It should be noted that the word “comprising” does not necessarily exclude the presence of other elements, features, functions, or steps than those listed and the words “a” or “an” preceding an element do not exclude the presence of a plurality of such elements, features, functions, or steps. It should further be noted that any reference signs do not limit the scope of the claims, that the example embodiments may be implemented at least in part by means of both hardware and software, and that several “means”, “units” or “devices” may be represented by the same item of hardware.

The various example embodiments described herein are described in the general context of methods, and may refer to elements, functions, steps or processes, one or more or all of which may be implemented in one aspect by a computer-program product, embodied in a computer-readable medium, including computer-executable instructions, such as program code, executed by computers in networked environments.

A computer-readable medium may comprise removable and/or non-removable storage device(s) including, but not limited to, Read Only Memory (ROM), Random Access Memory, RAM), which may be static RAM, SRAM, or dynamic RAM, DRAM. ROM may be programmable ROM, PROM, or EPROM, erasable programmable ROM, or electrically erasable programmable ROM, EEPROM. Suitable storage components for memory may be integrated as chips into a printed circuit board or other substrate connected with one or more processors or processing modules, or provided as removable components, for example, by flash memory (also known as USB sticks), compact discs (CDs), digital versatile discs (DVD), and any other suitable forms of memory. Unless not suitable for the application at hand, memory may also be distributed over a various forms of memory and storage components, and may be provided remotely on a server or servers, such as may be provided by a cloud-based storage solution.

Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

The memory used by any apparatus whatever its form or electronic apparatus described herein, for example, a vehicle, a component of the vehicle, such as the control system of the vehicle and/or the ADS of the vehicle, or of the remote system 12 (whether this is a standalone platform or distributed over a plurality of platforms, for example, as a cloud-based platform) accordingly comprise any suitable device readable and/or writeable medium, examples of which include, but are not limited to: any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry

Memory may store any suitable instructions, data or information, including a computer-program, software, an application including one or more of logic, rules, code, tables, etc. and/or other instructions capable of being executed by processing circuitry and, utilized by the apparatus in whatever form of electronic apparatus. Memory may be used to store any calculations made by processing circuitry and/or any data received via a user or communications or other type of data interface. In some embodiments, processing circuitry and memory are integrated. Memory may be also dispersed amongst one or more system or apparatus components. For example, memory may comprises a plurality of different memory modules, including modules located on other network nodes in some embodiments.

While embodiments of the inventive concepts are illustrated and described herein, the device may be embodied in many different configurations, forms and materials. The present disclosure is to be considered as an exemplification of the principles of the inventive concepts and the associated functional specifications for their construction and is not intended to limit the inventive concepts to the embodiments illustrated. Those skilled in the art will envision many other possible variations within the scope of the present inventive concepts.

The foregoing description of the embodiments of the inventive concepts has been presented for the purpose of illustration and is not intended to be exhaustive or to limit the invention to the precise forms disclosed. Persons skilled in the relevant art can appreciate that many modifications and variations are possible in light of the above teachings. It is therefore intended that the scope of the inventive concepts be limited not by this detailed description, but rather by the claims appended hereto.

1. A computer implemented method for monitoring an autonomous operating zone, AOZ, including a number of one or more autonomous vehicles, each vehicle with sensors arranged to detect an ego-position of the vehicle and relative positions of surrounding objects, the method comprising at an object location correlating entity:
receiving in real-time data from an autonomous vehicle operating in the AOZ, the real-time data comprising a report including an ego-position of the vehicle, one or more positions and/or poses of objects detected by the vehicle;
responsive to receiving the report:
determining a detected object location for each detected object based on the reported vehicle ego-position and reported detected object position relative to the vehicle ego-position;
determining a correlation for each determined object location with one or more expected object locations in the AOZ; and
determining if the object is an expected object or unexpected object at the determined object location based on the correlation meeting a correlation condition.

2. The computer-implemented method of claim 1, wherein the method further comprises:
classifying the type of detected object at the determined object location; and
disregarding the detected object from subsequent monitoring of the AOZ dependent on the classified type of the detected object.

3. The computer-implemented method of claim 1, wherein the method further comprises:
responsive to determining the location in the AOZ of a detected object, checking if the determined location is within a sub-area of the AOZ excluded from monitoring for unexpected objects, and if so, disregarding the detected object in subsequent monitoring of the AOZ.

4. The computer implemented method of claim 1, wherein the object location correlating entity comprises one or more other autonomous vehicles operating in the AOZ and/or a central unit configured to receive reports from vehicles operating in the AOZ.

5. The computer-implemented method of claim 1, wherein determining the correlation comprises comparing each determined detected object location with one or more expected object locations in the AOZ retrieved from a data store of expected static object locations, wherein if the determined detected object location meets the correlation condition, the detected object is classified as an expected static object at that location in the AOZ.

6. The computer-implemented method of claim 1, wherein determining the correlation comprises:
comparing in real-time the determined detected object location with one or more expected object locations in the AOZ and wherein the one or more expected object locations are locations of one or more vehicles reported in real-time by the one or more vehicles.

7. (canceled)

8. The computer-implemented method of claim 1, wherein the correlation is determined by:
determining the location in the AOZ of each detected object;
based on the reported timing information for each detected object, determining locations of moving actors in the AOZ; and
comparing the determined location of each detected object in the AOZ at the time of its detection by the vehicle with the determined location at that time of one or more moving actors in the AOZ, wherein if the determined location of a detected object in the AOZ at the time the object was detected correlates with the determine location of a moving actor at that time in the AOZ, the detected object is classified as an expected moving actor in the AOZ.

9. (canceled)

10. The computer-implemented method of claim 1, wherein the method further comprises:
determining a confidence score for each detected object determined to be an unexpected object at the determined location base on the number of one or more other vehicles of the plurality of vehicles which have also detected an object at that determined location in the AOZ.

11. The computer-implemented method of claim 1, wherein the method further comprises the correlating entity:
processing for at least one detected object reported in a received report, object behavioural information, wherein the correlating comprises comparing the object behavioural information with expected behavioural information for one or more expected actors in the AOZ, and wherein the at least one detected object is classified as an unexpected object and/or as an object having unexpected behaviour in the AOZ if the behaviour of the detected object does not match the behaviour of an expected object in the AOZ.

12. The computer-implemented method of claim 1, wherein the report includes timing information for when each object was detected by the vehicle or wherein timing information for when each object was detected by the vehicle is determined by the object location correlating entity based on a time when the real-time data report including the detected object was received by the correlating entity.

13. (canceled)

14. The computer-implemented method of claim 1, wherein the method further comprises the correlating entity:
receiving object behavioural information representing one or more movement, position, and/or pose characteristics of the object at one or more locations reported by a vehicle in the AOZ over a period of time; and
generating a behavioural pattern for that period of time for the detected object based on the received behavioural information, wherein the correlating comprises determining if the generated behavioural pattern correlates with a stored behaviour pattern comprising expected movement characteristics, positions and poses for an object at the detected one or more locations.

15. The computer-implemented method of claim 11, wherein the object behavioural information includes information representing a role of the object, and the method further comprises:
determining if the monitored movement characteristics and position of the moving object match expected movement characteristics and positions for the role of the object.

16. The computer-implemented method of claim 1, wherein the method further comprises:
determining a confidence score for a detected object to be an unexpected object.

17. The computer-implemented method of claim 16, wherein the confidence score increases depending on the number of other vehicles that also reported they had detected the unexpected object at that location in the AOZ.

18. The computer-implemented method of claim 1, wherein the correlation condition for the location of the detected object to match a location of an expected object comprises the correlation exceeding a minimum amount of correlation, and wherein method further comprises:
configuring the minimum amount of correlation for the AOZ.

19. (canceled)

20. (canceled)

21. The computer-implemented method of claim 1, wherein responsive to determining a detected object is an unexpected object, the method further comprises performing an action comprising one or more of the following:
generating an alert to an operator in the AOZ;
causing one or more autonomous vehicles operating on the site to shut-down or restrict or pause or slow operation in the AOZ or in a sub-area of the AOZ comprising at least the vicinity of the unexpected object in the AOZ;
shutting down all ADS in the AOZ or in a subarea of the AOZ in the vicinity of the detected object;
restricting operation in the entire AOZ, or only in the vicinity of the detected object to only allow operation by a vehicle having an ADS with a certain subset of functionality implemented; and
closing down a sub-area of the AOZ in the vicinity of the detected object and divert operations to other parts of the site to avoid the sub-area in the vicinity of the detected object.

22. An object location correlating system comprising:
memory;
one or more processors or processing circuitry;
computer-program code stored in the memory, which, when loaded from the memory and executed by the one or more processors or processing circuitry causes the object location correlating system to perform a method according to claim 1.

23. The object location correlating system according to claim 22, wherein the object location correlating system comprise a remote unit configured to monitor an AOZ.

24. The object location correlating system according to claim 22, wherein the object location correlating system comprises a vehicle operating in the AOZ.

25. A vehicle configured to operate in an autonomous operating zone, AOZ, the vehicle comprising:
an automated driving system, ADS;
a control system; and
a wireless communications capability,
wherein the control system is configured, responsive to the ADS detecting an object, to:
generate object position information comprising information from which an ego-position of the vehicle and a relative position and/or pose of the object to the vehicle can be determined, and
cause the object position information to be sent over a wireless communications link using the wireless communications capability of the vehicle to an object location correlating system according to claim 22.

26. (canceled)
